(19) United States
(12) Patent Application Publication
(10) Pub. No.: US 2015/0086231 A1
(43) Pub. Date: Mar. 26, 2015

(54) Fuser Assembly with Automatic Media Width Sensing and Thermal Compensation

(71) Applicant: Lexmark International, Inc., Lexington, KY (US)

(72) Inventors: Craig Palmer Bush, Lexington, KY (US); Jichang Cao, Lexington, KY (US); Michael C. Day, Lexington, KY (US); Russell Edward Lucas, Lexington, KY (US); Alexander Douglas Meade, Lexington (KY); Gregory L. Ream, Lexington, KY (US)

(21) Appl. No.: 14/496,896

(22) Filed: Sep. 25, 2014

Related U.S. Application Data
(60) Provisional application No. 61/883,036, filed on Sep. 26, 2013.

(51) Int. Cl. G03G 15/20

(52) U.S. Cl. CPC G03G 15/2039
USPC 399/69

(57) ABSTRACT

A fuser assembly for an electrophotographic imaging device includes a heater including a substrate, a resistive trace disposed and running along a length of the substrate for generating heat for fusing toner to a sheet of media when a current is passed therethrough, and at least three conductors for passing current through the resistive trace. The at least three conductors include a first conductor connected to a first end portion of the resistive trace, a second conductor connected to a second end portion of the resistive trace, and a third conductor connected to the resistive trace at a location between the first end portion and the second end portion thereof. A temperature sensor senses a temperature of an edge segment of the substrate. Based upon the temperature sensed, circuitry selects between the first conductor and the third conductor for passing current through the resistive trace.

### CROSS REFERENCES TO RELATED APPLICATIONS

Pursuant to 35 U.S.C. §119, this application claims the benefit of the earlier filing date of Provisional Application Ser. No. 61/883,036, filed Sep. 26, 2013, entitled “Fuser with Automatic Paper Width Sensing and Thermal Compensation,” the content of which is hereby incorporated by reference herein in its entirety.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Disclosure

The present disclosure relates generally to controlling a fuser assembly in an electrophotographic imaging device, and particularly to maintaining temperature levels in the fuser assembly to allow for multiple media widths to print at full speed without overheating any portion of the fuser assembly.

2. Description of the Related Art

In an electrophotographic (EP) imaging process used in printers, copiers and the like, a photosensitive member, such as a photoconductive drum or belt, is uniformly charged over an outer surface. An electrostatic latent image is formed by selectively exposing the uniformly charged surface of the photosensitive member. Toner particles are applied to the electrostatic latent image, and thereafter the toner image is transferred to a media sheet intended to receive the final image. The toner image is fixed to the media sheet by the application of heat and pressure in a fuser assembly. The fuser assembly may include a heated roll and a backup roll forming a fuser nip through which the media sheet passes. Alternatively, the fuser assembly may include a fuser belt, a heater disposed within the belt around which the belt rotates, and an opposing backup member, such as a backup roll.

In a belt fusing system, an endless belt surrounds a ceramic heater element. The belt is pushed against the heater element by a pressure roller to create a fusing nip. To be able to fuse the widest media that the printer is designed to print, the length of the heating region is typically about the same width or slightly longer than the width of the widest media supported by the printer. The fusing heat is typically controlled by measuring the temperature of the heating region with a thermistor held in intimate contact with the ceramic heater element and feeding the temperature information to a microprocessor-controlled power supply in the printer, which in turn applies power to the heater element when the temperature drops below a first predetermined level, and which interrupts power when the temperature exceeds a second predetermined level. In this way, the fuser is maintained within an acceptable range of fusing temperatures.

When a to-be-printed media sheet has a width narrower than the width of the widest media supported by the printer, overheating problems may occur because the media sheet removes heat from the fuser only in the portion of the fuser contacting the media. As the portion of the fuser beyond the width of the media sheet does not lose any heat to the media sheet, such portion of the fuser becomes hotter than the portion contacting the media sheet and can be damaged due to high temperature.

Since excessive thermal energy accumulated at the portion of the fuser not contacting the media (hereinafter “non-media portion”) during narrow media printing can cause damage to the fuser, it is desirable to control the amount of thermal energy accumulated at the non-media portion to be below a certain level so that the fuser will not be damaged. To control the thermal energy accumulated at the non-media portion of the fuser, prior attempts used sensors and/or user-provided information to detect media width. If the media width is less than the full width, process speed is typically reduced and/or the interpage gap is increased to limit the overheating of the non-media portion. By doing so, however, throughput of the printer is reduced when printing media sheet sizes that are less than the widest supported media size leading to reduced performance levels.

Further, as machine speeds increase, the tolerable range of media width variation at full speed becomes smaller. For example, in the case of printers operating at 60 ppm and above, a media width difference of 3-4 mm may be enough to cause problematic overheating in the small portion of the fuser beyond the media. In other example cases, printers are equipped with letter width or A4 width heaters. However, if the heater width does not match the media width, problems may occur. For example, printers designed for letter width media and operating at 60 ppm or greater may cause the non-media portion of the fuser to overheat if A4 width media is used. Conversely, if letter width media is used in a printer designed for A4 width media, toner that is on the portion of the letter width media beyond the A4 edge may not be sufficiently fused.

Accordingly, there is a need for an improved system for controlling thermal energy in a fuser assembly.

### SUMMARY

Embodiments of the present disclosure provide systems for controlling temperature of portions of a heater of a fuser assembly that would allow for an image forming device to operate substantially at full speed regardless of the width of a media being fused and without user intervention.

In one example embodiment, a fuser assembly for an electrophotographic imaging device includes a housing, an endless belt rotatably positioned about the housing and having an inner surface, a backup roll disposed substantially against the endless belt proximal to an outer surface thereof so as to form a fuser nip with the belt, and a heater disposed substantially within the housing. The heater includes a substrate and at least one resistive trace disposed along a surface of the substrate, running a length of the substrate and generating heat for fusing toner to a sheet of media when a current is passed therethrough. The heater further includes at least three conductors for passing current through the at least one resistive trace. The at least three conductors include a first conductor connected to a first end portion of the at least one resistive trace, a second conductor connected to a second end portion of the at least one resistive trace, and a third conductor connected to the at least one resistive trace at a first location between the first end portion and the second end portion of the at least one resistive trace. A temperature sensor is disposed on the substrate to sense a temperature thereof at a location that is offset from the first location for generating a signal having a value that is based upon the sensed temperature. Circuitry is communicatively coupled to the temperature sensor and the first and third conductors for comparing the signal generated by the temperature sensor with a predetermined value. Based upon the comparison, the circuitry selects between the first conductor and the third conductor for passing current through the at least one resistive trace.

In another example embodiment, the at least three conductors further includes a fourth conductor connected to the at least one resistive trace at a second location between the second end portion and the first location of the at least one resistive trace. The circuitry selects between the second conductor and the fourth conductor for passing the current through the at least one resistive trace based upon the comparison.

### BRIEF DESCRIPTION OF THE DRAWINGS

The above-mentioned and other features and advantages of the disclosed example embodiments, and the manner of attaining them, will become more apparent and will be better understood by reference to the following description of the disclosed example embodiments in conjunction with the accompanying drawings, wherein:

FIG. 1 is a schematic illustration of an image forming device including a fuser assembly according to an example embodiment.

FIG. 2 is a cross sectional view of the fuser assembly in FIG. 1.

FIG. 3 is an illustrative view a heater element of the fuser assembly in FIG. 2 for a reference-edge feed system according to an example embodiment.

FIG. 4 illustrates a control configuration for the heater element in FIG. 3 according to an example embodiment.

FIG. 5 illustrates a control configuration for the heater element in FIG. 3 according to another example embodiment.

FIG. 6 illustrates the heater element for the referenced-edge feed system including two parallel resistive traces according to an example embodiment.

FIG. 7 is an illustrative view of the heater element for a center-referenced feed system according to an example embodiment.

FIG. 8 illustrates a control configuration for the heater element in FIG. 7 according to an example embodiment.

FIG. 9 illustrates a control configuration for the heater element in FIG. 7 according to another example embodiment.

FIG. 10 illustrates a control configuration for the heater element in FIG. 7 according to yet another example embodiment.

FIG. 11 illustrates the heater element for the center-referenced feed system including two parallel resistive traces according to an example embodiment.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Terms such as “first”, “second”, and the like, are used to describe various elements, regions, sections, etc. and are not intended to be limiting. Further, the terms “a” and “an” herein do not denote a limitation of quantity, but rather denote the presence of at least one of the referenced item.

Furthermore, and as described in subsequent paragraphs, the specific configurations illustrated in the drawings are intended to exemplify embodiments of the disclosure and that other alternative configurations are possible.

Reference will now be made in detail to the example embodiments, as illustrated in the accompanying drawings. Whenever possible, the same reference numerals will be used throughout the drawings to refer to the same or like parts.

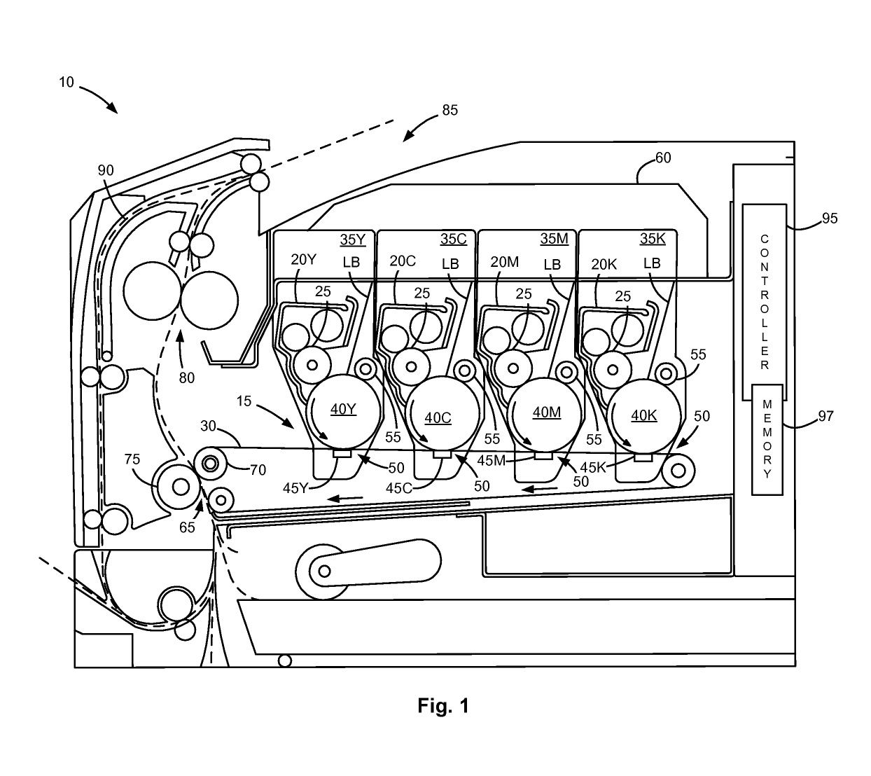

FIG. 1 illustrates an image forming device 10 according to an example embodiment. Image forming device 10 includes a first toner transfer area 15 having four developer units 20, including developer rolls 25, that substantially extend from one end of image forming device 10 to an opposed end thereof. Developer units 20 are disposed along an intermediate transfer member (ITM) 30. Each developer unit 20 holds a different color toner. The developer units 20 may be aligned in order relative to the direction of the ITM 30 indicated by the arrows in FIG. 1, with the yellow developer unit 20Y being the most upstream, followed by cyan developer unit 20C, magenta developer unit 20M, and black developer unit 20K being the most downstream along ITM 30.

Each developer unit 20 is operably connected to a toner reservoir 35 for receiving toner for use in a printing operation. Each toner reservoir 35 is controlled to supply toner as needed to its corresponding developer unit 20. Each developer unit 20 is associated with a photoconductive member 40 that receives toner therefrom during toner development to form a toned image thereon. Each photoconductive member 40 is paired with a transfer member 45 to define a transfer station 50 for use in transferring toner to ITM 30 at first transfer area 15.

During color image formation, the surface of each photoconductive member 40 is charged to a specified voltage by a charge roller 55. At least one laser beam LB from a printhead or laser scanning unit (LSU) 60 is directed to the surface of each photoconductive member 40 and discharges those areas it contacts to form a latent image thereon. In one embodiment, areas on the photoconductive member 40 illuminated by the laser beam LB are discharged. The developer unit 20 then transfers toner to photoconductive member 40 to form a toner image thereon. The toner is attracted to the areas of the surface of photoconductive member 40 that are discharged by the laser beam LB from LSU 60.

ITM 30 is disposed adjacent to each of developer unit 20. In this embodiment, ITM 30 is formed as an endless ITM disposed about a drive roller and other rollers. During image forming operations, ITM 30 moves past photoconductive members 40 in a clockwise direction as viewed in FIG. 1. One or more of photoconductive members 40 applies its toner image in its respective color to ITM 30. For mono-color images, a toner image is applied from a single photoconductive member 40K. For multi-color images, toner images are applied from two or more photoconductive members 40. In one embodiment, a positive voltage field formed in part by transfer member 45 attracts the toner image from the associated photoconductive member 40 to the surface of moving ITM 30.

ITM 30 rotates and collects the one or more toner images from the one or more photoconductive members 40 and then conveys the one or more toner images to a media sheet at a second transfer area 65. Second transfer area 65 includes a second transfer nip formed between a back-up roller 70 and a second transfer member 75.

A fuser assembly 80 is disposed downstream of second transfer area 65 and receives media sheets with the unfused toner images superposed thereon. In general terms, fuser assembly 80 applies heat and pressure to the media sheets in order to fuse toner thereto. After leaving fuser assembly 80, a media sheet is either deposited into an output media area 85 or enters duplex media path 90 for transport to second transfer area 65 for imaging on a second surface of the media sheet.

Image forming device 10 is depicted in FIG. 1 as a color laser printer in which toner is transferred to a media sheet in a two step operation. Alternatively, image forming device 10 may be a color laser printer in which toner is transferred to a media sheet in a single step process—from photoconductive members 40 directly to a media sheet. In another alternative embodiment, image forming device 10 may be a monochrome laser printer which utilizes only a single developer unit 20 and photoconductive member 40 for depositing black toner directly to media sheets. Further, image forming device 10 may be part of a multi-function product having, among other things, an image scanner for scanning printed sheets.

Image forming device 10 further includes a controller 95 and an associated memory 97. Memory 97 may be any volatile and/or non-volatile memory such as, for example, random access memory (RAM), read only memory (ROM), flash memory and/or non-volatile RAM (NVRAM). Alternatively, memory 97 may be in the form of a separate electronic memory (e.g., RAM, ROM, and/or NVRAM), a hard drive, a CD or DVD drive, or any memory device convenient for use with controller 95. Though not shown in FIG. 1, controller 95 may be coupled to components and modules in image forming device 10 for controlling same. For instance, controller 95 may be coupled to toner reservoirs 35, developer units 20, photoconductive members 40, fuser assembly 80 and/or LSU 60 as well as to motors (not shown) for imparting motion thereto. It is understood that controller 95 may be implemented as any number of controllers and/or processors for suitably controlling image forming device 10 to perform, among other functions, printing operations.

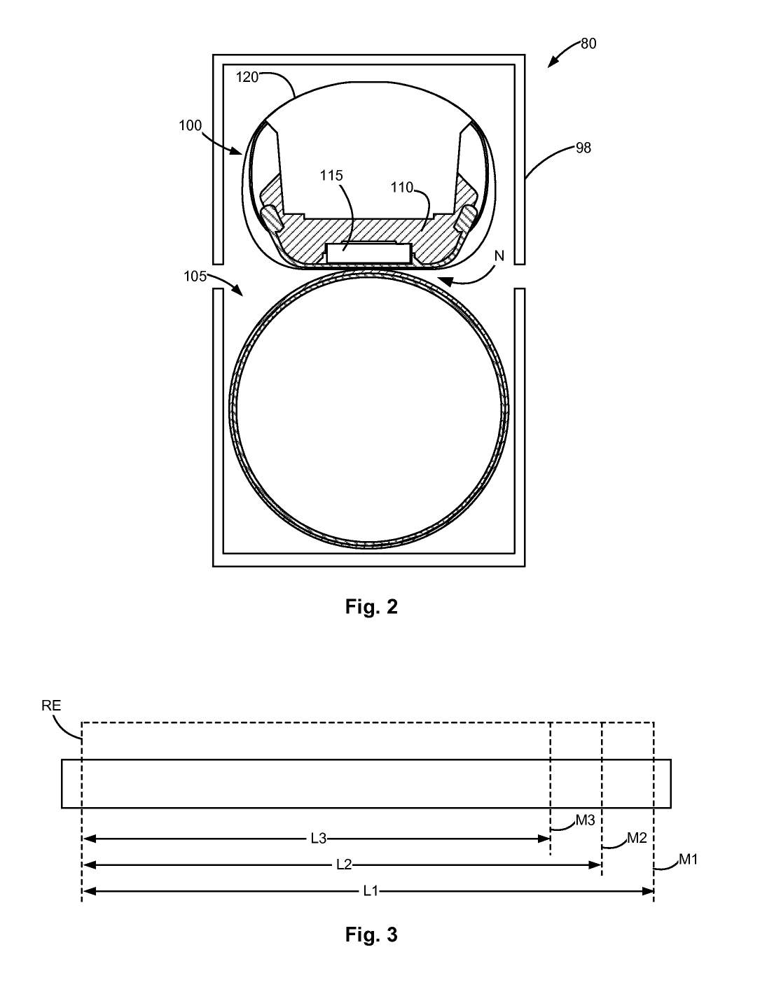

With reference to FIG. 2, fuser assembly 80 includes a fuser housing 98 which mounts a heat transfer member 100 and a backup roll 105 cooperating with the heat transfer member 100 to define a fuser nip N for conveying media sheets therein. The heat transfer member 100 may include a housing 110, a heater element 115 supported on or at least partially in housing 110, and an endless flexible fuser belt 120 positioned about housing 110. Heater element 115 has a length that extends substantially perpendicular to a media feed direction and may be formed from a substrate of ceramic or like material to which one or more resistive traces are secured which generate heat when a current is passed therethrough. Heater element 115 may further include at least one temperature sensor, such as a thermistor, coupled to the substrate for detecting a temperature of heater element 115. It is understood that heater element 115 alternatively may be implemented using other heat generating mechanisms.

Fuser belt 120 is disposed around housing 110 and heater element 115. Backup roll 105 contacts fuser belt 120 such that fuser belt 120 rotates about housing 110 and heater element 115 in response to backup roll 105 rotating. With fuser belt 120 rotating around housing 110 and heater element 115, the inner surface of fuser belt 120 contacts heater element 115 so as to heat fuser belt 120 to a temperature sufficient to perform a fusing operation to fuse toner to sheets of media.

Fuser assembly 80 may be configured for fusing toner to media sheets of different widths. With reference to FIG. 3, three different media sheets M1, M2, and M3 having different widths relative to a reference edge RE are shown, with media sheet M1 representing a widest supported media and media sheet M3 representing a narrowest supported media. In accordance with an example embodiment of the present disclosure, fuser assembly 80 may be controlled to selectively heat portions of the length of heater element 115 to desired fusing temperature levels depending on the width of a sheet of media passing through the fuser nip N such that the heated portion substantially matches with the media width in order to prevent overheating at non-media portions. For example, to perform a fusing operation to fuse toner to media sheet M1, a length L1 of heater element 115 corresponding to the width of media sheet M1 may be energized to generate sufficient amount of heat along length L1 for fusing toner. Likewise, in order to fuse toner to media sheets M2 and M3, lengths L2 and L3 of heater element 115, respectively, may be energized to generate sufficient amount of heat therealong for fusing toner. In this way, only portions of the heater element 115 contacted by the sheet of media passing through the fuser nip N are heated at fusing temperature levels such that non-media portions are substantially kept from accumulating excessive thermal energy that may otherwise cause overheating and damage to the fuser assembly 80.

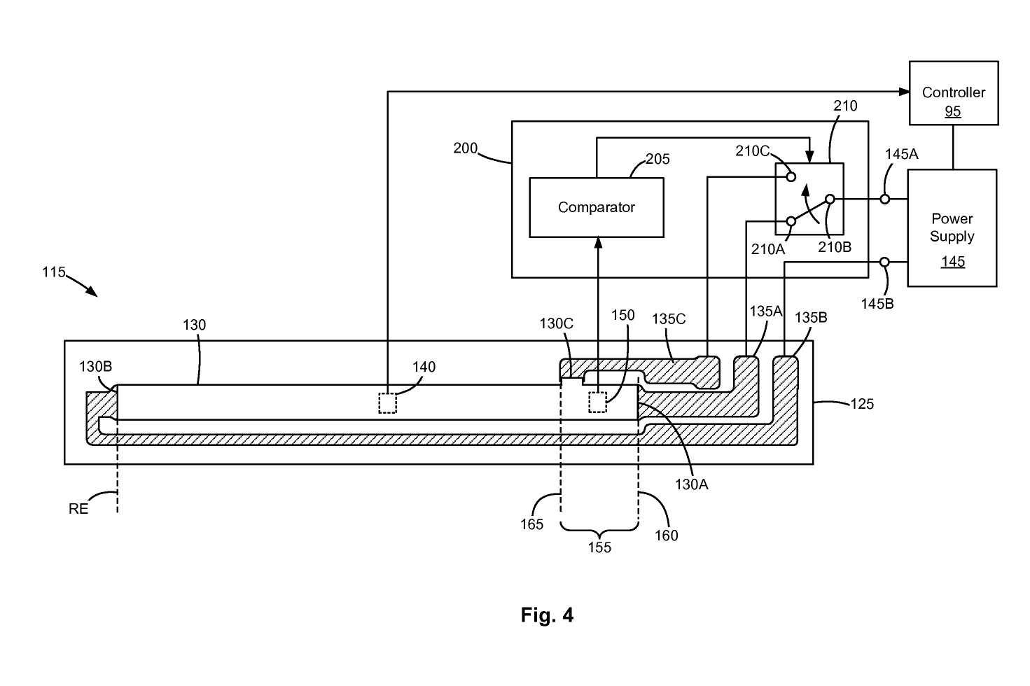

Referring now to FIG. 4, a control configuration, which can be used for controlling the temperature of heater element 115 in order to avoid overheating at non-media portions, is illustrated according to an example embodiment. Heater element 115 may include a substrate 125. Formed on a surface of substrate 125 is a resistive trace 130 extending from a first end portion 130A to a second end portion 130B across the length of substrate 125 and capable of generating heat when provided with electrical power. Substrate 125 and resistive trace 130 may be coated with a protective layer, such as a glass layer, which contacts the inner surface of fuser belt 120. Heater element 115 further includes a plurality of conductors 135 connected to resistive trace 130. Fusing temperature may be controlled by measuring the temperature of the substrate 125 with a temperature sensor 140 held in contact therewith and feeding the temperature information to controller 95 which in turn controls a power supply 145, such as an AC power supply, of imaging forming device 10 to apply power to heater element 115 based on the temperature information such that the fuser is maintained within an acceptable range of fusing temperatures. Temperature sensor 140 may be disposed on a side of heater element 115 opposite the surface along which resistive trace 130 is disposed.

Conductors 135 generally provide paths for electrical energy from power supply 145 to travel through resistive trace 130. In the example shown, first conductor 135A, second conductor 135B, and third conductor 135C are connected to resistive trace 130 at different locations thereof. In particular, first conductor 135A is connected to the first end portion 130A, second conductor 135B is connected to the second end portion 130B, and third conductor 135C is connected to resistive trace 130 at a location 130C that is laterally offset from the first end portion 130A and between the first and second end portions 130A, 130B. A temperature sensor 150 is coupled to substrate 125 at a location between the locations at which first conductor 135A and third conductor 135C are connected to resistive trace 130 for sensing a temperature of a substrate region corresponding to an edge segment 155 of the length of resistive trace 130. Temperature sensor 150 may be disposed on the side of heater element 115 opposite the surface along which resistive trace 130 is disposed.

In an example embodiment, the location at which first conductor 135A is connected to resistive trace 130 may correspond to an edge 160 (FIG. 4) of a widest supported media sheet, such as media sheet M1, while the location at which third conductor 135C is connected to resistive trace 130 may correspond to an edge 165 of a narrower supported media sheet, such as media sheet M2. The location at which second conductor 135B connects to resistive trace 130 may correspond to the reference edge RE of the media path. Generally, the various locations at which conductors 135 are connected to resistive trace 130 define points at which current enters and/or leaves resistive trace 130 when connected to power supply 145, as will be explained in greater detail below.

One or more of conductors 135 may be selectively coupled to power supply 145 by a control circuit 200 to control the flow of current through resistive trace 130 based on the temperature sensed by temperature sensor 150. In an example embodiment, control circuit 200 may be contained within fuser assembly 80. For example, control circuit 200 may be disposed on or within fuser housing 98. In addition, control circuit 200 may operate independently from controller 95. In particular, in the embodiment of FIG. 4, control circuit 200 operates without receiving control instructions from controller 95.

Control circuit 200 may include a comparator circuit 205 and a switch 210. As shown in FIG. 4, comparator circuit 205 has an input coupled to the output of temperature sensor 150, a second input (not shown) coupled to at least one reference signal corresponding to one or more predetermined temperature levels, and an output coupled to a control terminal of switch 210. Comparator circuit 205 receives signals generated by temperature sensor 150 having values that are based upon temperatures sensed thereby, compare the received signals with the at least one reference signal, and generate a signal at its output that is based upon the comparison. Comparator circuit 205 includes hysteresis, as explained in greater detail below. Switch 210 may be, for example, a mechanical switch, an electronic switch, a relay, or other switching device. As shown in FIG. 4, switch 210 includes a plurality of conduction terminals, such as a first conduction terminal 210A, a second conduction terminal 210B, and a third conduction terminal 210C so as to be a single pole, double throw type switch, and a control terminal. In the example shown, first conduction terminal 210A is connected to first conductor 135A of heater element 115, second conduction terminal 210B is connected to a first terminal 145A of power supply 145, and third conduction terminal 210C is connected to third conductor 135C of heater element 115. Further, switch 210 is communicatively coupled to the output of comparator circuit 205 and together provide a control mechanism for selecting and controlling a path of current through resistive trace 130 in order to control generation of heat therefrom without overheating. In particular, based on the output of comparator circuit 205, switch 210 may selectively connect one of the first and third conductors 135A, 135C to power supply 145 by switching connection between first and third conduction terminals 210A, 210C to second conduction terminal 210B. A second terminal 145B of power supply 145 is connected to second conductor 135B which, in an example embodiment, serves as a common return conductor.

In operation, controller 95 may control power supply 145 to provide electrical power to resistive trace 130 via first and second terminals 145A, 145B for heating heater element 115 to a target fusing temperature level. Switch 210 may connect first conduction terminal 210A to second conduction terminal 210B, as shown in FIG. 4, to allow current to flow between first conductor 135A and second conductor 135B of heater element 115. Temperature sensor 150, positioned proximate to edge segment 155 of resistive trace 130, may measure the temperature of the region corresponding thereto. Comparator circuit 205 compares the output voltage of temperature sensor 150 to a voltage corresponding to the first predetermined temperature level that is greater than the target fusing temperature level. In an example embodiment, the first predetermined temperature level may correspond to a temperature limit above which damage to fuser assembly 80 may occur. Detecting a voltage corresponding to a temperature that is below the first predetermined temperature level may indicate that the region corresponding to the edge segment 155 of resistive trace 130 is not overheating and/or that the sheet of media passing through the fuser nip N is a widest supported media, absorbing heat across length L1 of heater element 115. Accordingly, if the sensed temperature remains below the first predetermined temperature level, switch 210 may continue to keep the connection between the first conduction terminal 210A and second conduction terminal 210B to allow heating of length L1 of heater element 115 to the target temperature level to accommodate the detected sheet of widest supported media.

When fusing toner onto a sheet of narrower supported media while current flows between first conductor 135A and second conductor 135B of heater element 115, the temperature of the portion of heater element 115 corresponding to edge segment 155 may increase more rapidly than the temperature of the length of heater element 115 corresponding to the width of narrower supported media. In an example embodiment, detecting a temperature that exceeds the first predetermined temperature level may indicate that the region corresponding to the edge segment 155 of heater element 115 is overheating due to the sheet of narrower media passing through fuser nip N and absorbing heat energy of heater element 115 only along the length thereof contacted by the media sheet. Accordingly, if the temperature sensed by temperature sensor 150 exceeds the first predetermined temperature level, comparator circuit 205 compares the voltage corresponding to the sensed temperature with the voltage corresponding to the first predetermined temperature level and in response causes its output to switch binary states, which thereby causes switch 210 to disconnect its first conduction terminal 210A from second conduction terminal 210B so as to decouple first conductor 135A from power supply 145, and to connect third conduction terminal 210C to second conduction terminal 210B to couple third conductor 135C to power supply 145 and thereby cause current to flow between and through third conductor 135C and second conductor 135B. In this way, the current flow path is redirected such that only the length of heater element 115 contacted by the narrower media sheet is substantially heated to the target temperature level while preventing overheating at the non-media portion. In other words, a current path through heater element 115 is selected so that only the portion of heater element 115 corresponding to the location of the narrower media sheet is heated as the sheet is passed through fuser assembly 80.

In an example embodiment, comparator circuit 205 may further be configured to compare the voltage corresponding to the temperature sensed by temperature sensor 150 to a voltage corresponding to a second predetermined temperature level that is less than the first predetermined temperature level. The second predetermined temperature level may correspond to a temperature level in which the amount of thermal energy is not sufficient for fusing toner onto a sheet of media. Comparator circuit 205 comparing the voltage corresponding to the sensed temperature to voltages corresponding to both the first and second predetermined temperature levels is accomplished by comparator circuit 205 having hysteresis with switching voltages being the voltages corresponding to the first and second predetermined temperature levels. Comparator circuits having hysteresis are well known in the art such that a detailed description thereof will not be provided for reasons of simplicity. It is understood that the comparator circuits described below include hysteresis.

Heat generated by passing current through the portion of resistive trace 130 between and through third conductor 135C and second conductor 135B may transfer and/or dissipate in the longitudinal direction of heater element 115 and into edge segment 155, thereby heating edge segment 155 to some extent. In the event that a sheet of widest supported media is fed into fuser nip N while the current of resistive trace 130 passes through third conductor 135C, any heat transferred to edge segment 155 from the portion of heater element 115 between second conductor 135B and third conductor 135C may be absorbed by the sheet of media which may cause the temperature of edge segment 155 to drop below the second predetermined temperature level. In an example embodiment, detecting a temperature that is below the second predetermined temperature level may indicate that the sheet of media passing through fuser nip N is a widest supported media while heater element 115 is heated for fusing narrower media. If the sensed temperature is below the second predetermined temperature level, comparator circuit 205 may compare the voltage corresponding to the sensed temperature to the voltage corresponding to the second predetermined level and cause its output to change binary states to disconnect its third conduction terminal 210C from second conduction terminal 210B and thereby decouple third conductor 135C from power supply 145, and to connect first conduction terminal 210A to second conduction terminal 210A to couple first conductor 135A to power supply 145. This coupling establishes the current of resistive trace 130 to flow through first conductor 135A and second conductor 135B. Thus, control circuit 200 selects the current path through resistive trace 130 such that entire length L1 of heater element 115 is substantially heated to the target temperature level to accommodate the sheet of widest supported media.

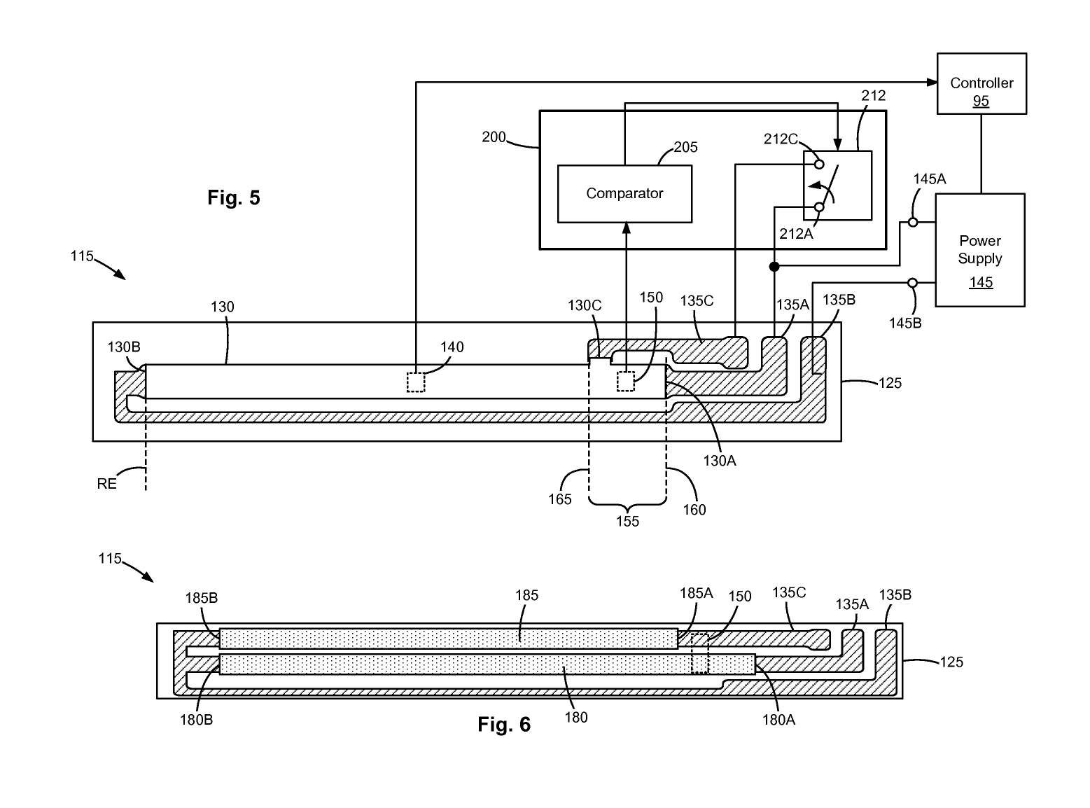

In an alternative example embodiment, control circuit 200 may employ a shunt configuration for switching the current between flowing through first conductor 135A and flowing through third conductor 135C. For example, in the embodiment shown in FIG. 5, control circuit 200 includes a single pole single throw (SPST) switch 212 having a first conduction terminal 212A connected to first conductor 135A and a second conduction terminal 212C connected to third conductor 135C, with the control terminal of switch 212 being coupled to the output of comparator circuit 205. Further, first conductor 135A and first conduction terminal 212A are connected to first terminal 145A of power supply 145. In this example, switch 212 either connects or disconnects first conduction terminal 212A to or from second conduction terminal 212C based on the output of comparator circuit 205. When switch 212 is open, the current flows through first conductor 135A and thus through the full length of resistive trace 130 between first conductor 135A and second conductor 135B. When switch 212 is closed, the current passes through switch 212 to third conductor 135C thereby bypassing edge segment 155 and causing current flow between third conductor 135C and second conductor 135B. As in the embodiment of FIG. 4, comparator circuit 205 may employ hysteresis in which the output of comparator circuit 205 changes state when signals received from temperature sensor 150 exceed or fall below reference signals corresponding to the first and second predetermined temperature levels, respectively.

In operation, when passing current through first conductor 135A (i.e., switch 212 being open for fusing wider media), in the event the temperature sensed by temperature sensor 150 exceeds the first predetermined temperature level (indicating narrower media being fused), comparator circuit 205 compares the voltage corresponding to the sensed temperature with the voltage corresponding to the first predetermined temperature level and causes the output of comparator circuit 205 to change binary state which closes switch 212 so that current is thereafter redirected through third conductor 135C (for fusing narrower media). In addition, when passing current through third conductor 135C (i.e., switch 212 being closed for fusing narrower media), in the event the temperature sensed by temperature sensor 150 falls below the second predetermined temperature level (indicating wider media being fused), comparator circuit 205 compares the voltage corresponding to the sensed temperature with the voltage corresponding to the second predetermined temperature level and causes the output of comparator circuit 205 to change binary state which opens switch 212 so that the current is redirected through first conductor 135A (for fusing wider media).

FIGS. 4 and 5 show heater element 115 having resistive trace 130 formed as a single trace. In another example embodiment, heater element 115 may include a plurality of resistive traces with each trace sized to accommodate a different media sheet size. For example, in FIG. 6, heater element 115 includes a first resistive trace 180 and a second resistive 185 having different lengths and extending parallel relative to each other. In this example, first resistive trace 180 has a length corresponding to the width of widest supported media M1, while second resistive trace 185 has a length that is less than the width of the first resistive trace 180 that corresponds to the width of narrower supported media M2. First conductor 135A is connected to a first end portion 180A of first resistive trace 180, second conductor 135B is connected to both second end portions 180B, 185B of first and second resistive traces 180, 185, respectively, and third conductor 135C is connected to a first end portion 185A of second resistive trace 185. Temperature sensor 150 is coupled to substrate 125 at a location between first end portion 180A of first resistive trace 180 and first end portion 185A of second resistive trace 185 for sensing the temperature of the region corresponding to difference in lengths between first resistive trace 180 and second resistive trace 185. Conductors 135A-135C are connected to control circuit 200 and power supply 145 in the same fashion as described with respect to FIG. 4 or FIG. 5 such that control circuit 200 may serve to provide the same function of selecting between conductors 135A and 135C for passing current through one of first resistive trace 180 and second resistive trace 185 depending on the media width ascertained from the temperature sensed by temperature sensor 150. Thus, control circuit 200 may automatically control current to flow through first resistive trace 180 when a sheet of widest supported media is being fused, or through second resistive trace 185 when a sheet of narrower supported media is being fused.

The above example embodiments have been described with respect to a reference-edge media feed system where one side of the media sheet is in a substantially constant location within fuser assembly 80 regardless of the media width. In another example embodiment, the applications described herein may also be used in center-referenced media feed systems where media sheets move at a center position along the media path and locations of both edges of the media sheet vary with media width.

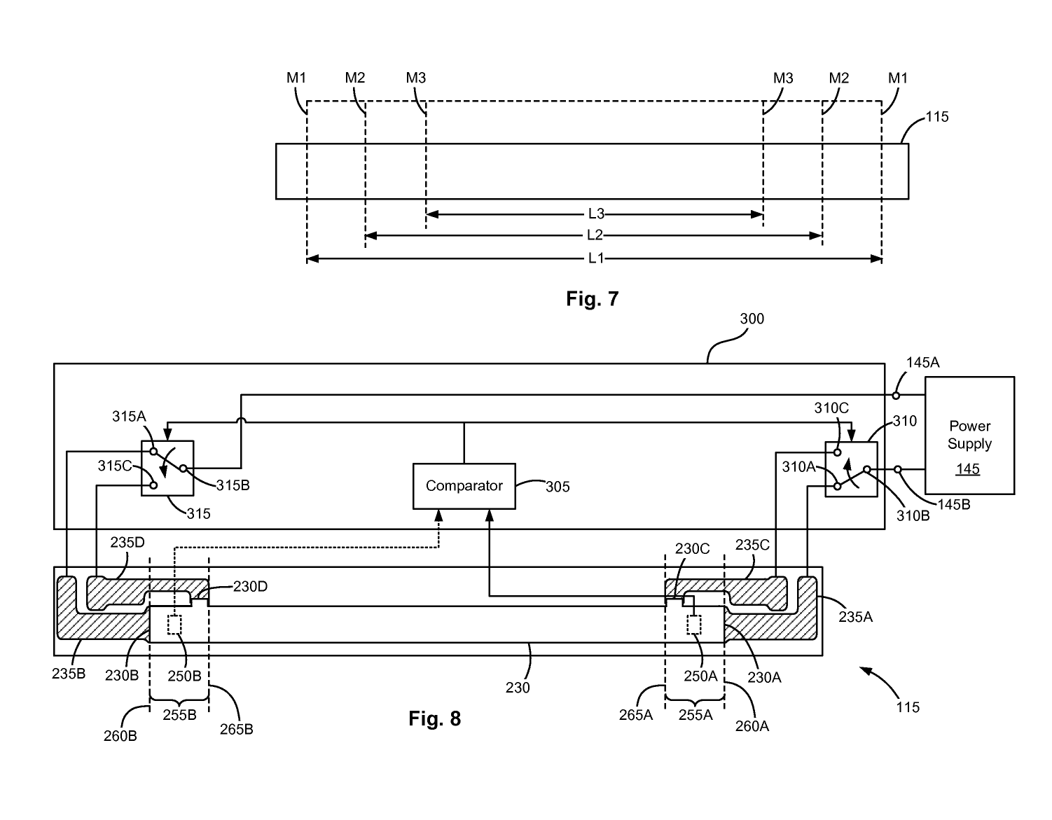

With reference to FIG. 7 depicting a center-referenced feed system, three media sheets M1, M2, and M3 having differing widths are illustrated with media sheet M1 being the widest and then decreasing in width through media sheets M2 and M3. To perform a fusing operation to fuse toner to media sheet M1, a length L1 of heater element 115 corresponding to the width of media sheet M1 may be energized to generate sufficient amount of heat along length L1 for fusing toner. Likewise, in order to fuse toner to media sheets M2 and M3, lengths L2 and L3 of heater element 115, respectively, may be energized to generate sufficient amount of heat therealong for fusing toner. In this way, only portions of the heater element 115 contacted by the sheet of media passing through the fuser nip N are heated at fusing temperature levels such that non-media portions along both edges of heater element 115 are substantially kept from accumulating excessive thermal energy that may otherwise cause overheating and damage to fuser assembly 80.

Referring now to FIG. 8, a control configuration, which can be used for controlling temperature levels of heater element 115 in a center-referenced feed system, is illustrated according to an example embodiment. Heater element 115 may include a resistive trace 230 extending between a first end portion 230A and a second end portion 230B. Heater element 115 further includes a plurality of conductors 235 which are coupled between power supply 145 and resistive trace 230 for providing current thereto. In the example shown, outer conductors include a first conductor 235A and a second conductor 235B connected to first and second end portions 230A, 230B of resistive trace 230, respectively. Inner conductors include a third conductor 235C and a fourth conductor 235D connected to resistive trace 230 at locations 230C, 230D between and laterally offset from respective end portions 230A, 230B. In this example, the locations at which first and second conductors 235A, 235B are connected to resistive trace 230 may correspond to edges 260A, 260B of the widest supported media M1, while the locations at which third and fourth conductors 235C, 235D are connected to resistive trace 230 may correspond to edges 265A, 265B of the narrower supported media M2. Accordingly, the distance between edges 260A and 260B corresponds to length L1 of heater element 115, while the distance between edges 265A and 265B corresponds to length L2 of heater element 115.

A first edge temperature sensor 250A may be coupled to the substrate of heater element 115 on a side opposite from the surface along which resistive trace 230 is disposed and at a location between the locations at which first and third conductors 235A, 235C are connected to resistive trace 230 for sensing a temperature of a region corresponding to a first edge segment 255A of resistive trace 230. Additionally or optionally, a second edge temperature sensor 250B may be coupled to the substrate of heater element 115 at a location between the locations at which second and fourth conductors 235B, 235D are connected to resistive trace 230 for sensing a temperature of a region corresponding to a second edge segment 255B of resistive trace 230 opposite the first edge segment 255A thereof.

Conductors 235 may be selectively coupled to power supply 145 by a control circuit 300 to control the flow of current through resistive trace 230 based on the temperature sensed by at least one of the first and second edge temperature sensors 250A, 250B. Control circuit 300 may include a comparator circuit 305 having hysteresis as described above, a first switch 310, and a second switch 315. Comparator circuit 305 has an input coupled to first edge temperature sensor 250A and an output coupled to first and second switches 310, 315. If second edge temperature sensor 250B is used, comparator circuit 305 may have a second input coupled thereto. Comparator circuit 305 may receive signals generated by each of the first and second edge temperature sensors 250A, 250B having values that are based upon temperatures sensed thereby, compare the received signals with one or more predetermined values corresponding to one or more predetermined temperature levels, and output a signal based upon the comparison.

Each of first switch 310 and second switch 315 includes a plurality of conduction terminals, such as first conduction terminals 310A, 315A, second conduction terminals 310B, 315B, and third conduction terminals 310C, 315C, respectively. First conduction terminals 310A, 315A are connected to first and second conductors 235A, 235B, respectively, while third conduction terminals 310C, 315C are connected to third and fourth conductors 235C, 235D, respectively. Second conduction terminal 310B of first switch 310 is connected to second terminal 145B of power supply 145 and second conduction terminal 315B of second switch 315 is connected to first terminal 145A of power supply 145. Control circuit 300 may select the conductors 235 for passing current through resistive trace 230 and specifically control current to flow either through first and second conductors 235A, 235B or through third and fourth conductors 235C, 235D. Comparator circuit 305 actuates first and second switches 310, 315 based on the temperature(s) sensed by at least one of the first and second edge temperature sensors 250A, 250B in order to control the generation of heat across at least portions of the length of resistive trace 230 to prevent overheating.

In operation, controller 95 may control power supply 145 to provide electrical power to resistive trace 230 via first and second terminals 145A, 145B for heating heater element 115 to a target fusing temperature level. First switch 310A is controlled to connect its first conduction terminal 310A to second conduction terminal 310B and second switch 315 is controlled to connect its first conduction terminal 315A to second conduction terminal 315B to cause current to flow in resistive trace 230 through conductors 235A and 235B. First and second edge temperature sensors 250A, 250B positioned proximate to the first and second end portions 230A, 230B of resistive trace 230 measure the temperature of the regions corresponding to first and second edge segments 255A, 255B, respectively.

Comparator circuit 305 compares the voltage corresponding to the temperature sensed by one or more of edge temperature sensors 250A, 250B to the voltage corresponding to the first predetermined temperature level. If the temperature(s) sensed is less than the first predetermined temperature level, it is indicative of a sheet of media having a width corresponding to media sheet M1 that does not result in overheating, and control circuit 300 may maintain current flow through resistive trace 230 via conductors 235A and 235B to accommodate fusing of media sheet M1. If any temperature sensed exceeds the first predetermined temperature level, it is indicative of overheating at regions corresponding to first edge segment 255A and/or second edge segment 255B due to narrower media sheet M2 being fused. In response, comparator circuit 305 actuates first and second switches 310, 315 which in turn disconnect corresponding first conduction terminals 310A, 315A from respective second conduction terminals 310B, 315B and connect corresponding third conduction terminals 310C, 315C to respective second conduction terminals 310B, 315B. Accordingly, a current flow path is established which allows current to flow through resistive trace 230 via third and fourth conductors 235C, 235D. In this way, current flow may be controlled to follow a path defined by the inner conductors such that fusing temperature levels may exist only within functional areas of heater element 115 corresponding to the width of the narrower sheet of media M2 while preventing overheating at the non-media portions.

In the event that a sheet of media M1 is fed into fuser nip N while the third and fourth conductors 235C, 235D are used to provide current through resistive trace 130, heat of the region corresponding to the edge segments 255A, 255B may drop due to heat absorption by the sheet of media at the edges thereof. In an example embodiment, comparator circuit 305 may further be configured to compare the voltage corresponding to the temperature sensed by at least one of the edge temperature sensors 250A, 250B to the voltage corresponding to the second predetermined temperature level. If the temperature sensed by one of the edge temperature sensors 250A, 250B falls below the second predetermined temperature level, and if the temperature sensed by the other edge temperature sensor 250A, 250B is below the first predetermined temperature, the output of comparator circuit 305 changes binary state to actuate first and second switches 310, 315 to disconnect corresponding third conduction terminals 310C, 315C from respective second conduction terminals 310B, 315B and connect corresponding first conduction terminals 310A, 315A to respective second conduction terminals 310B, 315B. Accordingly, a resistive trace current flow path is established through first and second conductors 235A and 235B, respectively, such that the length of heater element 115 corresponding to the width of the sheet of media M1 is heated to the target temperature level to accommodate fusing of the entire width of the sheet of media.

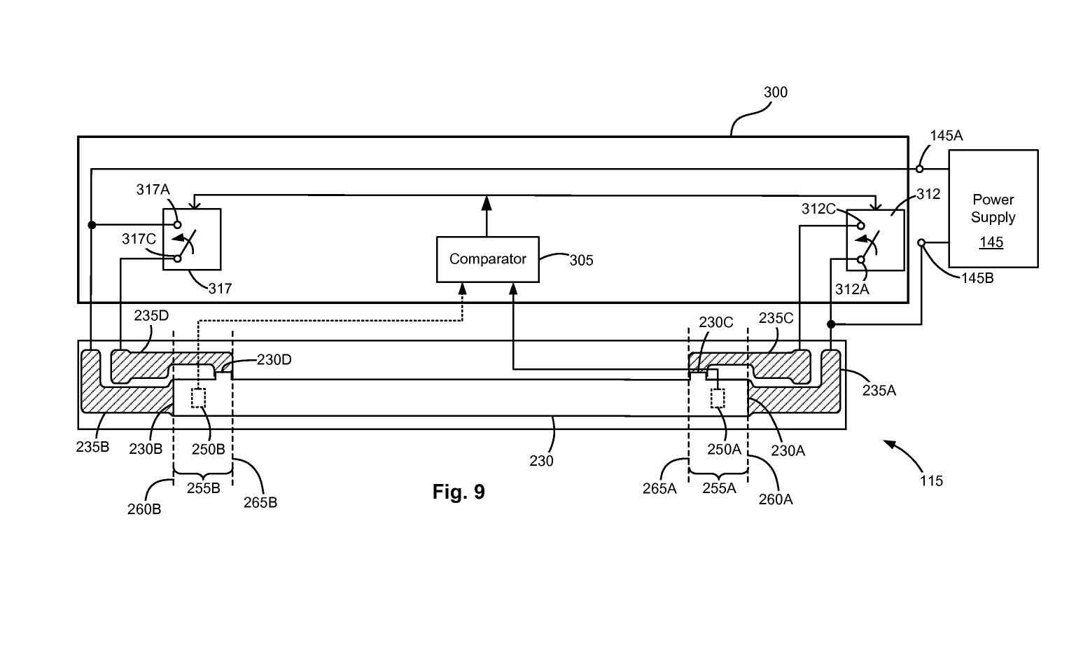

FIG. 9 illustrates another example embodiment. The embodiment of FIG. 9 generally uses the control configuration of the embodiment of FIG. 8, for controlling temperature levels of heater element 115 in a center-referenced feed system. Similar to the embodiment of FIG. 5, however, SPST switch 312 is used to selectively short first conductor 235A and third conductor 235C, and SPST switch 317 is used to selectively short second conductor 235B and fourth conductor 235D, based upon the output of comparator circuit 305. During the time the output of comparator circuit 305 causes switches 312 and 317 to be open, thereby causing current to pass through first conductor 235A and second conductor 235B for fusing wider media, when the temperature sensed by any edge temperature sensor 250A and 250B rises above the first predetermined temperature level (indicating narrower media being fused), comparator circuit 305 compares the voltage corresponding to the sensed temperature with the voltage corresponding to the first predetermined temperature level and causes the output of comparator circuit 305 to change binary state which closes switches 312 and 317, which thereby causes current of resistive trace 230 to flow through third conductor 235C and fourth conductor 235D for fusing narrower media. During the time the output of comparator circuit 305 causes switches 312 and 317 to be closed, thereby causing current to pass through third conductor 235C and fourth conductor 235D for fusing narrower media, when the temperature sensed by one of the edge temperature sensors 250A and 250B falls below the second predetermined temperature level and if the temperature sensed by the other edge temperature sensor 250A, 250B is below the first predetermined temperature (indicating wider media being fused), comparator circuit 305 compares the voltage corresponding to the sensed temperature to the voltage corresponding to the second predetermined temperature level and causes the output of comparator circuit 305 to change binary state which opens switches 312 and 317, which thereby causes current of resistive trace 230 to flow through first conductor 235A and second conductor 235B for fusing narrower media. In the embodiments in which a single comparator circuit 305 receives sensor data from two edge temperature sensors 250A, 250B, such as the embodiments illustrated in FIGS. 8 and 9, comparator circuit 305 favors fusing narrower media in which resistive trace current is passed through third conductor 235C and fourth conductor 235D so that the transition from fusing narrower media to fusing wide media occurs only if neither one of edge temperature sensors 250A, 250B has a temperature greater than the first predetermined temperature level.

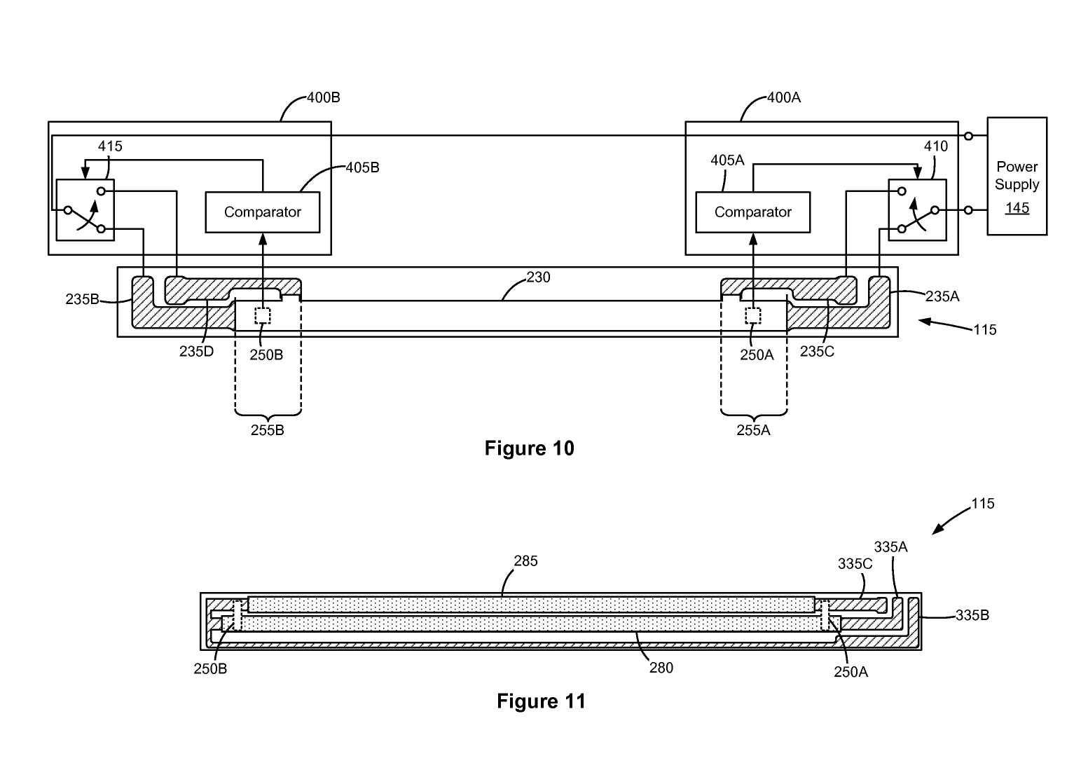

In an alternative example embodiment shown in FIG. 10, the first edge segment 255A and second edge segment 255B of resistive trace 230 may be equipped with separate control circuits 400A and 400B, respectively. Conductors 235 associated with the first and second edge segments 255A, 255B and corresponding edge temperature sensors 250A, 250B may be connected to corresponding control circuits 400A, 400B and power supply 145 in the same fashion as described above with respect to FIG. 4. In this example, each control circuit 400A, 400B may serve to provide the function of independently switching switches 410, 415 using comparator circuits 405A, 405B, respectively, to control the flow of current through resistive trace 230.

In another example embodiment, heater element 115 may include a plurality of resistive traces of differing lengths to accommodate multiple media sheet sizes in a center-referenced feed system. For example, in FIG. 11, heater element 115 may include a first resistive trace 280 and a second resistive 285 extending parallel relative to each other. In the example shown, first resistive trace 280 may have a length corresponding to the width of media sheet M1, while second resistive trace 285 may have a length corresponding to the width of media sheet M2. Conductors 335A, 335B, 335C and edge temperature sensor 250 may be coupled to a control circuit in a similar manner as described above with respect to FIGS. 4 and 6 such that the control circuit may serve to provide the same function of controlling current to flow either through first resistive trace 280 when fusing a widest supported media sheet M1, or through second resistive trace 285 when fusing a narrower sheet of media M2. It is further contemplated that in other alternative example embodiments, the aforementioned control circuits used for controlling temperature in center-referenced feed systems may employ the shunt configuration described above with respect to FIGS. 5 and 9.

Illustrative examples of control configurations have been described using three or four conductors, one or two resistive traces, and a given number of comparator circuits and switches that would accommodate two different media sheet sizes. However, it is understood that a multiplicity of conductors, resistive traces, and any number of comparator circuits or switches may be implemented to accommodate more than two media sheet sizes.

With the above example embodiments, one or both edges of the heater element 115 may be equipped with self-controlling segments to prevent overheating the edge segments thereof. Temperature information sensed by temperature sensor(s) at the edge segments may be fed to one or more control circuits which in turn controls the switching of one or more switches to select a current path through and otherwise control the flow of current through the resistive trace and, consequently, control at least portions of the resistive trace to heat to desired temperature levels based on the temperature information. Accordingly, no operator intervention may be needed to configure fuser assembly 80 for the media width being used, and fuser assembly 80 can operate substantially at full speed regardless of which media width is being used. Additionally, since control circuitries are contained within the fuser assembly 80 and since no logic, temperature feedback, or additional interaction/communication is required between the fuser assembly control circuitry and the image forming device controller, any image forming device can be configured as a multiple-media width imaging device by simply removing a traditional single-width fuser and installing a multiple-width fuser equipped with self-controlling segments described herein.

The foregoing description of several example embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A fuser assembly for an electrophotographic imaging device, comprising:
a housing;
an endless belt rotatably positioned about the housing and having an inner surface;
a backup roll disposed substantially against the endless belt proximal to an outer surface thereof so as to form a fuser nip with the belt; and
a heater disposed substantially within the housing, the heater comprising:
a substrate;
at least one resistive trace disposed along a surface of the substrate, the at least one resistive trace running a length of the substrate and generating heat for fusing toner to a sheet of media when a current is passed therethrough; and
at least three conductors for passing current through the at least one resistive trace, the at least three conductors comprising a first conductor connected to a first end portion of the at least one resistive trace, a second conductor connected to a second end portion of the at least one resistive trace, and a third conductor connected to the at least one resistive trace at a first location between the first end portion and the second end portion of the at least one resistive trace;
a temperature sensor disposed on the substrate to sense a temperature of the substrate at a location that is offset from the first location, the temperature sensor generating a signal having a value that is based upon the sensed temperature; and
circuitry communicatively coupled to the temperature sensor and the first and third conductors, the circuitry comparing the signal generated by the temperature sensor with a predetermined value, and based upon the comparison, selecting between the first conductor and the third conductor for passing current through the at least one resistive trace.

2. The fuser assembly of claim 1, wherein the circuitry comprises a comparator for comparing the signal generated by the temperature sensor with the predetermined value, and a switch having a control terminal coupled to an output of the comparator, a first conduction terminal coupled to the first conductor, a second conduction terminal coupled to the third conductor.

3. The fuser assembly of claim 2, wherein during a fusing operation in which current passes through the first conductor, if the signal generated by the temperature sensor rises above the predetermined value, the comparator causes the switch to redirect the current to pass through the third conductor; and when the current passes through the third conductor, if the signal generated by the temperature sensor falls below a second predetermined value that is less than the first predetermined value, the comparator causes the switch to redirect the current to pass through the first conductor.

4. The fuser of claim 2, wherein the switch includes a third conduction terminal, the switch controlling an electrical connection of the third conduction terminal between the first and second conduction terminals based upon the output of the comparator.

5. The fuser of claim 2, wherein the switch controls an electrical connection between the first and second conduction terminals based upon the output of the comparator.

6. The fuser assembly of claim 1, wherein the location of the temperature sensor on the substrate corresponds to a location in the fuser nip which an edge portion of a sheet of a first media size contacts when passing through the fuser nip and which is not contacted by a sheet of a second media size less than the first media size when passing through the fuser nip.

7. The fuser assembly of claim 1, wherein the at least three conductors further comprises a fourth conductor connected to the at least one resistive trace at a second location between the second end portion and the first location of the at least one resistive trace, the circuitry selecting between the second conductor and the fourth conductor for passing the current through the at least one resistive trace based upon the comparison.

8. The fuser assembly of claim 7, wherein the circuitry comprises comparator circuitry for comparing the signal generated by the temperature sensor with the predetermined value, switching circuitry having at least one control terminal coupled to the output of the comparator circuitry and conduction terminals coupled to the first, second, third and fourth conductors, the switching circuitry selectively redirecting current between the first and third conductors and between the second and fourth conductors for passing the current through the at least one resistive trace based upon the output of the comparator circuitry.

9. The fuser assembly of claim 7, wherein the switching circuitry comprises at least two switch devices, each of the at least two switch devices comprises one of a single pole, single throw type switch device and a single throw, double throw type switch device.

10. The fuser assembly of claim 1, further comprising a fuser housing in which at least the housing, the endless belt and the backup roll are housed, wherein the circuitry is disposed on or within the fuser housing.

11. A heater assembly for a fuser unit of an electrophotographic imaging device, comprising:
a substrate;
at least one resistive trace disposed on the substrate and running along a length thereof, the at least one resistive trace for generating heat for fusing toner to a sheet of media when current is passed therethrough;
at least three conductors for passing current through the at least one resistive trace, the at least three conductors comprising:
a first conductor connected to a first end portion of the at least one resistive trace;
a second conductor connected to a second end portion of the at least one resistive trace opposite the first end portion; and
a third conductor connected to the at least one resistive trace at a first location between the first and second end portions of the at least one resistive trace;
a temperature sensor coupled to the substrate at a location between attachment points of the first and third conductors to the at least one resistive trace, the temperature sensor for sensing a temperature of an edge segment of the substrate between the first location and the first end portion; and
circuitry communicatively coupled to the temperature sensor and operative to control current passing through the at least one resistive trace, by switching between passing the current through the first conductor and passing the current through the third conductor, based on the temperature sensed by the temperature sensor.

12. The heater assembly of claim 11, wherein when passing the current through the first conductor, the circuitry redirects the current to pass through the at least one resistive trace via the third conductor if the sensed temperature rises above a predetermined temperature level, and when passing current through the third conductor, the circuitry and redirects the current to pass through the first conductor if the sensed temperature falls below a second predetermined temperature level less than the first predetermined temperature level.

13. The heater assembly of claim 12, wherein the circuitry includes a comparator circuit for comparing a signal generated by the temperature sensor based on the sensed temperature with a predetermined value corresponding to the predetermined temperature level, and a switch having a control terminal coupled to the comparator circuit and conduction terminals coupled to the first and third conductors.

14. The heater assembly of claim 11, wherein the at least one resistive trace comprises a first resistive trace coupled between the first and second conductors, and a second resistive trace extending substantially parallel relative to the first resistive trace and coupled between the third and second conductors.

15. The heater assembly of claim 14, wherein the second resistive trace has an end coupled to the second conductor that is offset from an end of the first resistive trace coupled to the second conductor.

16. The heater assembly of claim 11, wherein the at least three conductors further comprise a fourth conductor connected to the at least one resistive trace at a second location between the first location and the second end portion of the at least one resistive trace, the circuitry operative to switch between passing the current through the second conductor and the fourth conductor.

17. The heater assembly of claim 16, further comprising a second temperature sensor coupled to the substrate for sensing a second temperature of a second edge segment of the substrate between the second end portion and the second location, wherein the circuitry is coupled to the second temperature sensor and operative to control the current to switch between passing through the second conductor and the fourth conductor based upon the temperature sensed by the second temperature sensor.

18. The heater assembly of claim 16, wherein when passing the current through the first and second conductors, the circuitry redirects the current to pass through the at least one resistive trace via the third and fourth conductors if the sensed temperature rises above the predetermined temperature level, and when passing current through the third and fourth conductors, the circuitry and redirects the current to pass through the first and second conductors if the sensed temperature falls below a second predetermined temperature level less than the first predetermined temperature level.

19. The heater assembly of claim 18, wherein the circuitry includes a comparator circuit for comparing a signal generated by the temperature sensor based on the sensed temperature with a predetermined value corresponding to the predetermined temperature level, and switching circuitry coupled to the comparator circuit, the comparator circuit operative to connect one of the first and third conductors to a power supply and to connect one of the second and fourth conductors to the power supply based upon the comparison to allow passage of the current through at least portions of the length of the at least one resistive trace.

20. A heater element for a fuser of an electrophotographic imaging device, comprising:
a substrate;
at least one resistive trace disposed on a surface of the substrate and running along a length thereof; and
a first conductor connected to a first end portion of the at least one resistive trace, a second conductor connected to a second end portion of the at least one resistive trace opposite the first end portion thereof, and a third conductor connected to the at least one resistive trace at a first location between the first and second end portions thereof, the first, second, and third conductors for passing current through at least portions of the at least one resistive trace;
wherein applying electrical energy from a power source to the first and second conductors causes the current to pass through the at least one resistive trace between the first and second end portions thereof, and applying electrical energy to the third and second conductors causes the current to pass through the at least one resistive trace between the second end portion and the first location thereof.
